(19) United States
(12) Patent Application Publication
(10) Pub. No.: US 2017/0337570 A1
(43) Pub. Date: Nov. 23, 2017

(54) ANALYTICS SYSTEM FOR PRODUCT RETENTION MANAGEMENT

(71) Applicant: International Business Machines Corporation, Armonk, NY (US)

(72) Inventors: Tara Astigarraga, Fairport, NY (US); Nada Santiago, Poughkeepsie, NY (US); Christina A. Lara, Tucson, AZ (US); Maria R. Ward, Pflugerville, TX (US)

(21) Appl. No.: 15/156,462

(22) Filed: May 17, 2016

(51) Int. Cl. G06Q 30/02; G06K 7/14

(52) U.S. Cl. CPC G06Q 30/0202; G06K 7/1413; G06K 7/1417

(57) ABSTRACT

A computer analytically determines market acceptance of a softline good (SG) to assist a user whether he or she should retain the SG. The computer determines background data associated with the SG from a code upon the SG and may determine additional background data associated with the SG from another computer, such as a computer of a SG supply chain entity, via a network. The computer analytically determines a market acceptance curve of the SG and compares the analytically determined market acceptance curve with the user's predetermined market acceptance threshold. If the market acceptance of the SG is congruent with the user's predetermined market acceptance threshold, the computer recommends for the user to retain the SG and if the market acceptance of the SG is not congruent with the user's predetermined market acceptance threshold, the computer recommends for the user to not retain the SG.

### FIELD OF THE INVENTION

Embodiments of the invention generally relate to computers and more particularly to a computer that provides product retention analytics to a user.

### DESCRIPTION OF THE RELATED ART

A softline good (SG) is a consumer product within apparel, shoe and accessory categories generally fabricated from soft, flexible materials. As opposed to a SG, a hardline good has a sturdier, less flexible structure or is sold within inflexible packaging. Generally, market trends that effect consumer market adoption of SGs have a shorter duration than the market trends that effect consumer market adoption of hardline goods. In some instances, the market trends of SGs are so short or dynamically change such that it has become difficult for the SG consumer to determine whether he or she should retain a particular SG.

### SUMMARY

In an embodiment of the present invention, a method of managing retention of a SG with a computer which includes a processor and memory includes scanning, with a user I/O device module stored upon the memory, an image of a code upon a label that is attached to the SG to determine a SG identifier, generating, with a SG profile module stored upon the memory, a SG profile comprising the SG identifier, generating, with an analytics module stored upon the memory, a first market acceptance curve from first harvested data from a first assigned data space, generating, with the analytics module, a second market acceptance curve from second harvested data from a second assigned data space, generating, with the analytics module, a best fit market acceptance curve of the first market acceptance curve and the second market acceptance curve, and recommending, with the analytics module, whether the SG should be retained by determining whether the best fit market acceptance curve extends beyond a predetermined market acceptance threshold of a user of the computer.

In another embodiment of the present invention, a computer program product for managing retention of a SG with a computer which includes a computer readable storage medium having program instructions embodied therewith. The program instructions are readable by the computer to cause the computer to scan an image of a code upon a label that is attached to the SG to determine a SG identifier, generate a SG profile comprising the SG identifier, generate a first market acceptance curve from first harvested data from a first assigned data space, generate a second market acceptance curve from second harvested data from a second assigned data space, generate a best fit market acceptance curve of the first market acceptance curve and the second market acceptance curve, recommend whether the SG should be retained by determining whether the best fit market acceptance curve extends beyond a predetermined market acceptance threshold of a user of the computer.

In yet another embodiment of the present invention, a computer includes a processor and a memory communicatively coupled to the processor. The memory is encoded with instructions that which when executed by the processor cause the processor to scan an image of a code upon a label that is attached to the SG to determine a SG identifier, generate a SG profile comprising the SG identifier, generate a first market acceptance curve from first harvested data from a first assigned data space, generate a second market acceptance curve from second harvested data from a second assigned data space, generate a best fit market acceptance curve of the first market acceptance curve and the second market acceptance curve, and recommend whether the SG should be retained by determining whether the best fit market acceptance curve extends beyond a predetermined market acceptance threshold of a user of the computer.

These and other embodiments, features, aspects, and advantages will become better understood with reference to the following description, appended claims, and accompanying drawings.

### BRIEF DESCRIPTION OF THE DRAWINGS

FIG. 1 illustrates a high-level block diagram of an exemplary computer for implementing various embodiments of the invention.

FIG. 2 illustrates a block diagram of a background-data module stored in memory of the computer that when invoked by the computer processor causes the computer to implement various embodiments of the present invention.

FIG. 3 illustrates a block diagram of an analytics module stored in memory of the computer that when invoked by the computer processor causes the computer to implement various embodiments of the present invention.

FIG. 4A illustrates an exemplary online marketplace acceptance curve generated by online marketplace acceptance curve module, according to embodiments of the present invention.

FIG. 4B illustrates an exemplary social media market acceptance curve generated by social media market acceptance curve module, according to embodiments of the present invention.

FIG. 4A illustrates an exemplary online periodical market acceptance curve generated by online periodical market acceptance curve module, according to embodiments of the present invention.

FIG. 4D illustrates a market acceptance curve with market acceptance threshold overlaid thereupon, according to embodiments of the present invention.

FIG. 4E illustrates an analytically determined market acceptance curve with market acceptance threshold overlaid thereupon, according to embodiments of the present invention.

FIG. 5 illustrates an exemplary method of determining a computer user's market acceptance threshold, according to various embodiments of the present invention.

FIG. 6 illustrates an exemplary method of analytically determining a market acceptance curve of a SG, according to various embodiments of the present invention.

FIG. 7 illustrates an exemplary method of determining background data of a SG, according to various embodiments of the present invention.

FIG. 8 illustrates an exemplary method of determining a market acceptance curve of a SG, according to various embodiments of the present invention.

FIG. 9 illustrates an exemplary method of managing retention of a SG based upon an analytically determined market acceptance curve of the SG, according to various embodiments of the present invention.

FIG. 10 illustrates a block diagram of an example computing environment in which illustrative embodiments of the present disclosure may be implemented.

FIG. 11 illustrates a block diagram of an exemplary system architecture, including a natural language processing system, configured to use product reviews to rank product features, in accordance with embodiments of the present disclosure.

It is to be noted, however, that the appended drawings illustrate only example embodiments of the invention, and are therefore not considered a limitation of the scope of embodiments of the invention.

### DETAILED DESCRIPTION

Embodiments relate to a computer analytically determining market trends of a SG to assist a user whether he or she should retain the SG. The computer determines background data associated with the SG from a bar code upon the SG and may determine additional background data associated with the SG from another computer, such as a computer of the SG manufacturer, computer of the retailer, or computer of another supply chain entity via a network. The computer analytically determines a market acceptance curve of the SG and compares the analytically determined market acceptance curve with the user's predetermined market acceptance threshold. If the analytically determined market acceptance curve indicates that the market acceptance of the SG is congruent with the user's predetermined market acceptance threshold, the computer recommends for the user to retain the SG. If the analytically determined market acceptance curve indicates that the market acceptance of the SG is not congruent with the user's predetermined market acceptance threshold, the computer recommends for the user to not retain the SG.

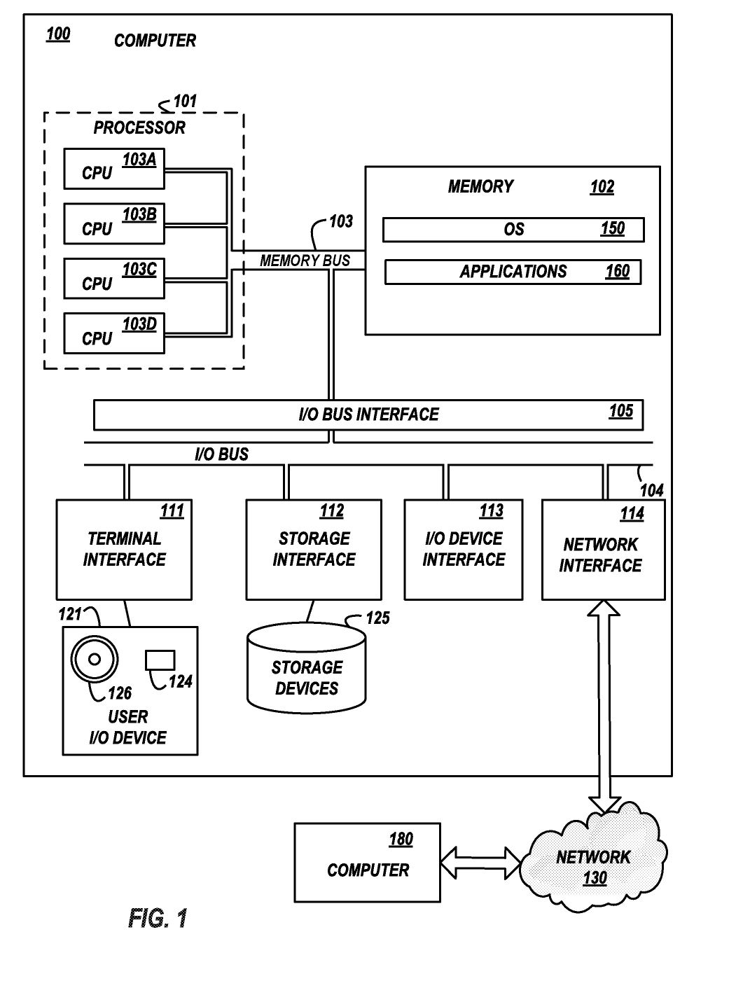

Referring to the Drawings, wherein like numbers denote like parts throughout the several views, FIG. 1 depicts a high-level block diagram representation of a computer 100 connected to another computer 180 via a network 130, according to an embodiment of the present invention. Computer 180 may include the same components, less components, or additional components as computer 100. The term “computer” is used herein for convenience only, and in various embodiments is a more general data handling system, such as a mobile phone, tablet, server computer, etc. The mechanisms and apparatus of embodiments of the present invention apply equally to any appropriate data handling system. In a particular embodiment, computer 100 is a client computer such as a mobile phone and computer 180 is a host computer such as a server.

The major components of the computer 100 may comprise one or more processor 101, system memory 102, terminal interface 111, storage interface 112, I/O (Input/Output) device interface 113, and/or network interface 114, all of which are communicatively coupled, directly or indirectly, for inter-component communication via one or more busses, such as memory bus 103, I/O bus 104, an I/O bus interface unit 105, etc.

The computer 100 contains one or more general-purpose programmable central processing units (CPUs) 103A, 103B, 103C, and 103D, herein generically referred to as processor 101. In embodiments, the computer 100 contains multiple processors 101 typical of a relatively large system such as a server computer. Each processor 101 executes instructions stored in the system memory 102 and may comprise one or more levels of on-board cache. One of the multiple processors 101 may be a coprocessor. Generally, the coprocessor also executes instructions stored in the system memory 102 and may comprise one or more levels of on-board cache. The coprocessor generally allows the processor 101 to offload the execution of some instructions stored in the system memory 102 allowing the processor 101 to execute other instructions stored in the system memory 102. For example, the processor 101 may offload the execution of analytic instructions to the coprocessor. The coprocessor may also operate upon data that was previously operated upon by the processor 101 or upon data that will be subsequently operated upon by the processor 101. The offloading to the coprocessor generally allows for improved performed of particular instructions stored in the system memory 102. As such, the coprocessor may also be referred to as an accelerator, acceleration unit, or the like.

In an embodiment, the system memory 102 may comprise a random-access semiconductor memory, storage device, or storage medium for storing or encoding data and programs. In another embodiment, the system memory 102 represents the entire virtual memory of the computer 100, and may also include the virtual memory of other computers coupled to the computer 100 or connected via the network 130. The system memory 102 is conceptually a single monolithic entity, but in other embodiments the system memory 102 is a more complex arrangement, such as a hierarchy of caches and other memory devices. For example, memory 102 may exist in multiple levels of caches, and these caches may be further divided by function, so that one cache holds instructions while another holds non-instruction data, which is used by the processor 101. Memory may be further distributed and associated with different processors 101 or sets of processors 101, as is known in any of various so-called non-uniform memory access (NUMA) computer architectures.

The system memory 102 stores or encodes an operating system 150, and applications 160, and/or other program instructions. Although the operating system 150, applications 160, etc. are illustrated as being contained within the memory 102 in the computer 100, in other embodiments some or all of them may be on a different computer 180 and may be accessed remotely, e.g., via the network 130. The computer 100 may use virtual addressing mechanisms that allow the programs of the computer 100 to behave as if they only have access to a large, single storage entity instead of access to multiple, smaller storage entities. Thus, while operating system 150, applications 160, or other program instructions are illustrated as being contained within the system memory 102, these elements are not necessarily all completely contained in the same storage device at the same time. Further, although operating system 150, applications 160, other program instructions, etc. are illustrated as being separate entities, in other embodiments some of them, portions of some of them, or all of them may be packaged together, etc.

In an embodiment, operating system 150, application 160, and/or other program instructions comprise instructions or statements that execute on the one or more processors 101 and/or instructions or statements that are interpreted by instructions or statements that execute on the one or more processors 101 to carry out the functions as further described below. When such program instructions are able to be run by the one or more processors 101, such computer 100 becomes a particular machine configured to carry out such instructions.

One or more processors 101 may function as a general-purpose programmable graphics processor unit (GPU) that builds images (e.g. a GUI) for output to a display. The GPU, working in conjunction with one or more applications 160, determines how to manipulate pixels of a display, such as touch screen 124, to create a display image or user interface. Ultimately, the image (e.g. GUI, etc.) is displayed to a user via the display, such as touch screen 124. The processor 101 and GPU may be discrete components or may be integrated into a single component.

The memory bus 103 provides a data communication path for transferring data among the processor 101, the system memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). In a particular embodiment, the terminal interface unit 111 is attached to camera 126 and touch screen 124 combination I/O device 121. The camera 126 and touch screen 124 combination allows the user to gesture, or touch, the touch screen 124 to instruct the computer 100 to capture and image with camera 126. A user may manipulate the user input devices using a user interface, in order to provide input data and commands to the user I/O device 121 and the computer 100, and may receive output data via the user output devices. For example, the interface may be presented via the user I/O device 121, such as displayed on a display device, played via a speaker, or printed via a printer. The user interface may be a user interface that provides content to a user visually (e.g. via a screen), audibly (e.g. via a speaker), and/or via touch (e.g. vibrations, etc.). In some embodiments, the computer 100 itself acts as the user interface as the user may move the computer 100 in ways to interact with, input, or manipulate computer application 160 data, function, etc.

The storage interface unit 112 supports the attachment of one or more disk drives or storage devices 125. In an embodiment, the storage devices 125 are rotating magnetic disk drive storage devices, but in other embodiments they are arrays of disk drives configured to appear as a single large storage device to a host computer, or any other type of storage device. The contents of the system memory 102, or any portion thereof, may be stored to and retrieved from the storage devices 125, as needed. The storage devices 125 have a slower access time than does the memory 102, meaning that the time needed to read and/or write data from/to the memory 102 is less than the time needed to read and/or write data from/to for the storage devices 125.

The I/O device interface 113 provides an interface to any of various other input/output devices or devices of other types, such as printers or fax machines. The network interface 114 provides one or more communications paths from the computer 100 to other data handling devices such as numerous other computers (e.g., computer 180); such paths may be comprised within, e.g., one or more networks 130.

Although the memory bus 103 is shown in FIG. 1 as a relatively simple, single bus structure providing a direct communication path among the processors 101, the system memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

Network interface 114 may contain electronic components and logic to adapt or convert data of one protocol on I/O bus 104 to another protocol. Therefore, network interface 114 may connect a wide variety of devices to computer 100 and to each other such as, but not limited to, servers, computers, bus adapters, PCI adapters, PCIe adapters, NVLink adapters, or computer 180 using one or more protocols including, but not limited to, Token Ring, Gigabyte Ethernet, Ethernet, Fibre Channel, SSA, Fiber Channel Arbitrated Loop (FCAL), Serial SCSI, Ultra3 SCSI, Infiniband, FDDI, ATM, 1394, ESCON, wireless relays, Twinax, LAN connections, WAN connections, high performance graphics connections, etc.

Though shown as distinct entities, the multiple I/O interface units 111, 112, 113, and 114 or the functionality of the I/O interface units 111, 112, 113, and 114 may be integrated into the same device, adapter, etc.

In various embodiments, the computer 180 is a multi-user mainframe computer, a single-user system, a server computer, storage system, or similar device that has little or no direct user interface, but receives requests from other computers, such as computer 100. In such embodiments, the computer 100 may be implemented as a desktop computer, portable computer, laptop or notebook computer, tablet computer, pocket computer, telephone, smart phone, automobile infotainment console, teleconferencing system, appliance, or any other appropriate type of electronic device. In other embodiments, the computer 100 and computer 180 may be the same type of computer.

The network 130 may be any suitable network or combination of networks and may support any appropriate protocol suitable for communication of data and/or code to/from the computer 100 and at least the computer 180. In various embodiments, the network 130 may represent a data handling device or a combination of data handling devices, either connected directly or indirectly to the computer 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

FIG. 1 is intended to depict the representative major components of the computer 100. The individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program instructions implementing e.g. upon computer 100 according to various embodiments of the invention may be implemented in a number of manners, including using various computer applications, routines, components, programs, objects, modules, data structures, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory

signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

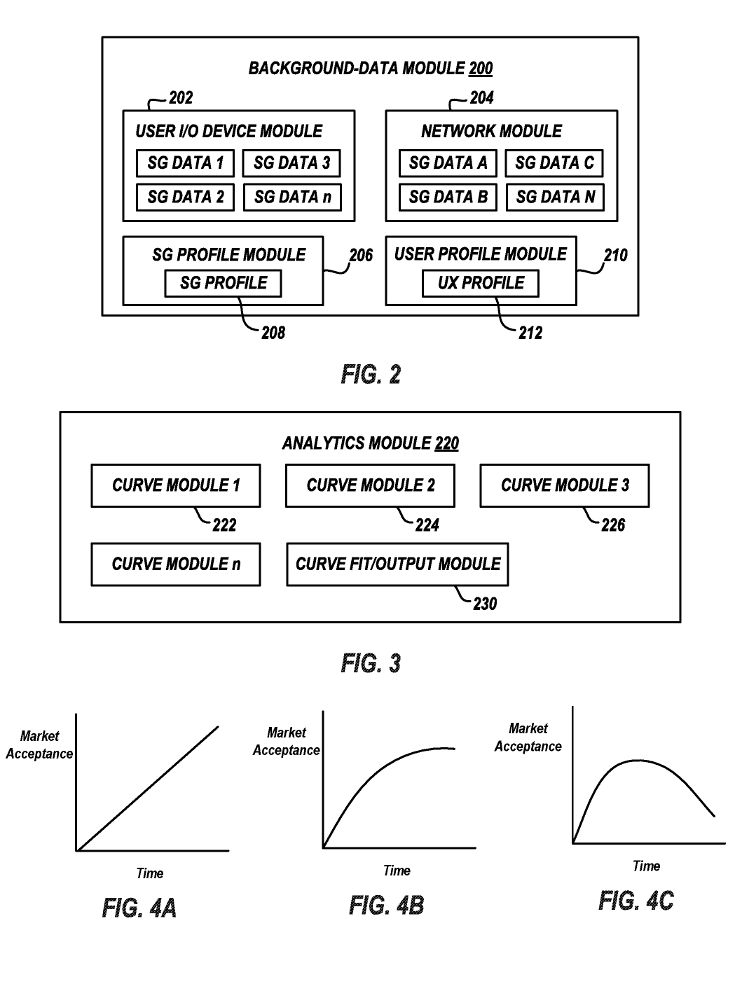

FIG. 2 illustrates a block diagram of a background-data module 200 stored in memory 102 that when invoked by processor 101 causes the computer 100 to implement SG background-data accumulation operations. Background-data module 200 may include user I/O device module 202, network module 204, SG profile module 206, and user profile module 210.

User I/O device module 202 is stored in memory 102 and when is invoked by processor 101, causes the computer 100 to utilize I/O device 121 to accumulate background SG data. Similarly, network module 204 is stored in memory 102 and when is invoked by processor 101, causes the computer 100 to request and receive background SG data from computer 180 via network 130.

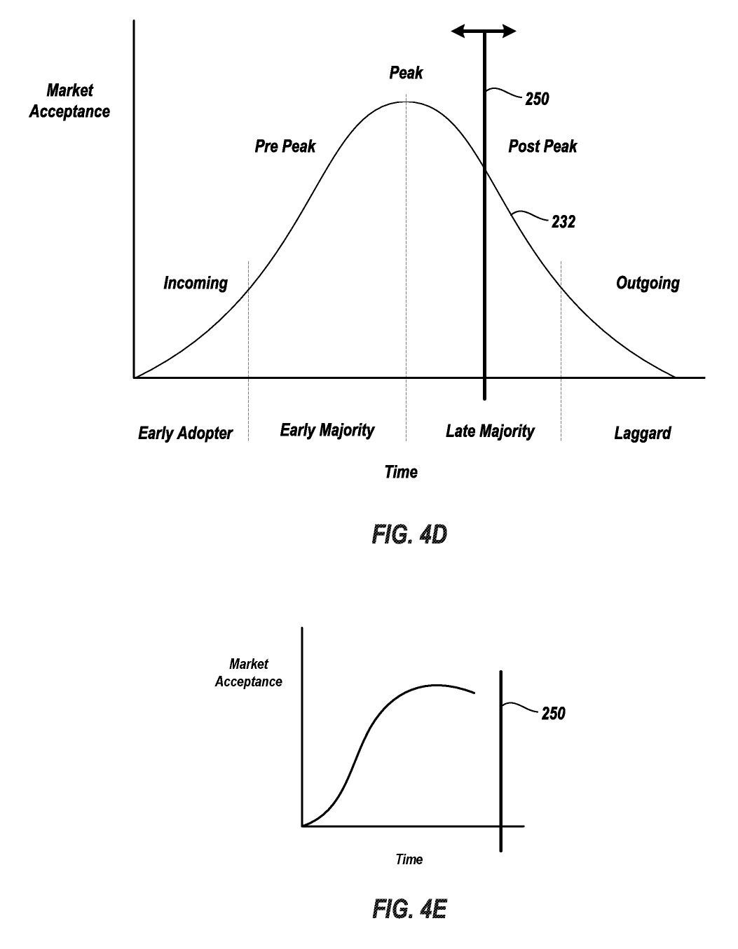

SG profile module 206 is stored in memory 102 and when is invoked by processor 101, causes the computer 100 to create a SG profile 208 utilizing the background SG data accumulated by User I/O device module 202 and retrieved by network module 204 (if present). SG profile 208 is a set of data that describes the SG and may be stored in memory 102 or in one or more storage devices 125. Similarly, user profile module 210 is stored in memory 102 and when is invoked by processor 101, causes the computer 100 to create one or more user profiles 212. A user profile 212 is a set of data that at least defines the user's market acceptance threshold 250, as is exemplary shown in FIG. 4D, for a class of SGs and may be stored in memory 102 or in one or more storage devices 125. Multiple user profiles 212 may exist to establish a unique or different user's market acceptance threshold 250 for each associated particular class of SGs.

In a preferred embodiment, the user I/O devices 121 are a camera 126 and touch screen 124 and user I/O device module 202 causes the computer 100 the camera 126 and touch screen 124 to accumulate background SG data. In the present embodiment, the computer 100 user captures an image of a code, such as a Universal Product Code (UPC) code, Quick Response (QR) code, or the like, that is located upon, attached to, or otherwise associated with the SG. The code may be integral to the soft material of the SG, may be located upon a manufacture's label attached to the SG, may be located upon a retailer's stock control label attached to the SG, or the like. Subsequently, user I/O device module 202 scans the image of the code to read or accumulate background data of the associated SG. If the code is a UPC code, user I/O device module 202 scans the image of the UPC code to determine background SG data, generally depicted as SG data 1-SG data n associated with the particular SG. Exemplary background SG data may be an identifier of the SG, manufacturer of the SG, manufacturing location of the SG, price of the SG, style of the SG, cut of the SG, color of the SG, material of the SG, size of the SG, date of sale of the SG, date SG placed for sale, or the like. In other embodiments, the I/O device 121 generally reads the code and accumulates background SG data therefrom. Generally, user I/O device module 202 accumulates background data of the SG by utilizing user I/O device(s) 121.

Network module 204 generally requests and receives background data, generally depicted as SG data A-SG data N associated with the particular SG, that is inherent to, integral to, or otherwise associated with the SG that was known at the time of initial sale or that was created or relates to the time subsequent the time of initial sale of the SG to the first consumer from a networked connected computer 180 by an entity other than the user of computer 100. For example, the entity that controls or otherwise manages the computer 180 may be the retailer that made the initial sale of the SG, manufacturer of the SG, or the like. Exemplary background SG data may be product recall information of the SG, sales trend data of the SG, manufacturing location of the SG, sale price of the SG, sale price discount history of the SG, expected market acceptance curve of the SG, to date market acceptance curve of the SG, customer recommendation data of the SG, time on floor before purchase, retail location of purchase, or the like. Since the computer 180 is controlled or managed by an entity other than that of computer 100, the quantity, quality, etc. of any background data SG data A-SG data N received by computer 100 is unknown. In an embodiment, network module 204 sends a specific request for particular background data from computer 180 and in another embodiment, network module 204 sends a blanket requests for any and all background data SG data A-SG data N. The background data SG data A-SG data N returned by computer 180 is generally structured data such that computer 100 knows to what the data refers. For example, computer 180 returns to computer 100 a data quantity $102.99 along with reference data describing to what or how that data quantity refers to the SG (e.g., the SG was sold for $102.99, a promotion or discount of $102.99 was given, etc.).

SG profile module 206 generally assembles the background SG data 1-SG data n and any background SG data A-SG data N into a SG profile 208 which is a data package that describes the particular SG. The SG profile 208 of each SG of the user may be stored in memory 102, in storage device 125, etc.

User profile module 210 determines a user profile 212 of the user of computer 100. User profile module 210 may be a question and answer module which queues questions to and receives inputs from the user of computer 100. The user profile 212 is a data package that at least defines the computer 100 user market acceptance threshold 250, as is exemplary shown in FIG. 4D. The term market acceptance threshold is the point in time and the point in market acceptance along a market acceptance trend curve which defines the consumer type that is acceptable to the user. In an embodiment, the user profile module 210 determines a user profile 212 which contains a single market acceptance threshold 250 that defines the point of time and the point of market acceptance along a market acceptance trend curve which indicates the consumer type that is acceptable to the user for all SGs. In another embodiment, the user profile module 210 determines a user profile 212 which contains multiple market acceptance thresholds 250. Each particular market acceptance threshold 250 is associated with a particular SG, a particular category of SG, a particular class of SG, or the like and defines the point of time and the point of market acceptance along a market acceptance trend curve which indicates the consumer type that is acceptable to the user for the particular SG, the particular category of SG, the particular class of SG, or the like. For example, a market acceptance threshold 250 may be associated with the SG category of footwear, a market acceptance threshold 250 may be associated a particular class of footwear such as casual footwear, a market acceptance threshold 250 may be associated with a particular SG manufacturer or retailer, a market acceptance threshold 250 may be associated with a particular SG color, a market acceptance threshold 250 may be associated with a particular SG material, or the like. The user profile 212, and particularly the market acceptance threshold 250, is utilized to determine a retention suggestion of the particular SG.

FIG. 3 illustrates a block diagram of an analytics module 220 stored in memory 102 that when invoked by processor 101 causes the computer 100 to implement SG analytically determined market acceptance data harvesting operations. Analytics module 220 may include one or more market acceptance curve modules and a curve fit output module 230. In a particular embodiment, analytics module 220 includes an online marketplace acceptance curve module 222, a social media market acceptance curve module 224, and an online periodical market acceptance curve module 226. The term harvested data, or the like utilized herein with reference to analytics module 220 means market acceptance data that is found by analytic operations by analytics module 220 from within an associated assigned data space.

Online marketplace acceptance curve module 222 utilizes the SG profile 208 as an input and analytically harvests online retail data, online sales data, or the like, to determine the marketplace acceptance of the SG in the online marketplace. Generally, online marketplace acceptance curve module 222 determines change over time of the number of instances the SG appear in online sales webpages. The online marketplace acceptance curve module 222 may determine whether the SG is still offered for sale, determine the number of online retailers offering the SG for sale, determine the brand ranking of the online retailer(s) offering the SG for sale, determine the number, date, rate, or the like of product reviews of the SG on the product page each online retailer offering the SG for sale, determine ratio number of prestigious online retailers to total number of online retailers selling the SG, determine the number of similar SG for sale by online retailers, or the like. The online marketplace acceptance curve module 222 may crawl or harvest data from the current in time webpage relating to the SG and may crawl or harvest cached past webpages related to (e.g., selling, or the like) the SG to determine the trend of marketplace acceptance of the SG. For example, by crawling past webpages, the online marketplace acceptance curve module 222 may determine the number of online retailers selling the SG over time, determine change of prestige of the online retailers selling the SG over time, or the like. The online marketplace acceptance curve module 222 assembles the analytically harvested online retail data, online sales data, or the like, into an online marketplace acceptance curve, as is exemplary shown in FIG. 4A.

Social media market acceptance curve module 224 utilizes the SG profile 208 as an input and analytically harvests social media data to determine the marketplace acceptance of the SG. Generally, social media market acceptance curve module 224 determines the number of instances of the SG posted to social media webpages over time. The social media market acceptance curve module 224 may crawl social media webpages, scan social media images, or the like to determine the change over time of the number of instances the SG was identified in in social media webpages. For example, social media market acceptance curve module 224 may determine the number of images posted to social media webpages over time that contain the SG, determine the number of written comments posted social media webpages over time about the SG, the change over time of the ranking of user that posts comments or images about the SG in social media webpages, determine the change over time of the number and ranking of users mentioning the SG in social media webpages, determine the change over time of the number and ranking of users posting an image of the SG in social media webpages, determine the number of instances over time the SG, SG retailer, or the like has been favorited by social media users, determine the number of instances over time the SG has been shared over time by social media users, determine the number of instances over time the SG has been added to social media users' webpages over time. The social media market acceptance curve module 224 may crawl and harvest social media data from current social media webpages and past cached social media webpages. The social media market acceptance curve module 224 assembles the analytically harvested social media data into a social media marketplace acceptance curve, as is exemplary shown in FIG. 4B.

Online periodical market acceptance curve module 226 utilizes the SG profile 208 as an input and analytically harvests online periodical data to determine the marketplace acceptance of the SG. Generally, online periodical market acceptance curve module 226 determines the number of instances the SG is contained within periodical webpages over time. The term periodical is used herein to include magazine webpages, blog webpages, etc. The online periodical market acceptance curve module 226 may crawl periodical webpages, scan periodical webpage images, or the like to determine the change over time of the number of instances the SG was identified in in periodical webpages. For example, online periodical market acceptance curve module 226 may determine the number of images posted to periodical webpages over time that contain the SG, determine the number of written comments posted periodical webpages over time about the SG, the change over time of the ranking of periodical that posts comments or images about the SG in its periodical webpage, determine the change over time of the number and ranking of periodicals mentioning the SG in their periodical webpages, determine the change over time of the number and ranking of periodicals posting an image of the SG in its periodical webpage. The line periodical market acceptance curve module 226 may crawl and harvest social media data from current periodical webpages and past cached periodical webpages. The online periodical market acceptance curve module 226 assembles the analytically harvested periodical webpage data into a periodical market acceptance curve, as is exemplary shown in FIG. 4C.

Curve fit output module 230 obtains the online marketplace acceptance curve, the social media marketplace acceptance curve, and the periodical market acceptance curve from online marketplace acceptance curve module 222, social media market acceptance curve module 224, and online periodical market acceptance curve module 226, respectively. The curve fit output module 230 subsequently overlays the online marketplace acceptance curve, the social media marketplace acceptance curve, and the periodical market acceptance curve normalizing the dimensions of each of the axis, respectively, and fits a best market acceptance curve.

FIG. 4A illustrates an exemplary analytically determined online marketplace acceptance curve generated by online marketplace acceptance curve module 222. The online marketplace acceptance curve depicts a change over time of the number of instances the SG appears in an image or description within online sales webpages up to a present time.

FIG. 4B illustrates an exemplary analytically social media market acceptance curve generated by social media market acceptance curve module 224. The social media market acceptance curve depicts a change over time of the number of instances of the SG appears in an image or description within social media webpages up to a present time.

FIG. 4C illustrates an exemplary analytically online periodical market acceptance curve generated by online periodical market acceptance curve module 226. The online periodical market acceptance curve depicts a change over time of the number of instances the SG appears in an image or description within periodical webpages over time.

FIG. 4D illustrates a market acceptance curve 232 with market acceptance threshold 250 overlaid thereupon, according to embodiments of the present invention. The market acceptance curve 232 depicts the change over time of market acceptance of a SG. When a SG is introduced into the marketplace the SG is accepted by a first group of consumers, deemed early adopters that e.g., purchase the SG during an incoming market acceptance period of the SG. Subsequent to the incoming period, the SG is then accepted by a second group of consumers, deemed early majority that e.g., purchase the SG during a pre peak market acceptance period of the SG. The maximum market acceptance of the SG is deemed the peak market acceptance. Subsequent to the peak, the SG is then accepted by a third group of consumers, deemed late majority that e.g., purchase the SG during a post peak market acceptance period of the SG. Subsequent to the post peak period, the SG is then accepted by a fourth group of consumers, deemed the laggards that e.g., purchase the SG during an outgoing market acceptance period of the SG. Generally, the term marketplace acceptance is an indication of degree in which the SG has been accepted by a sufficiently large number of consumers. Marketplace acceptance could be number of purchases, number of consumer's intent to purchase, number of positive impressions, or the like.

FIG. 4D also depicts acceptance threshold 250 overlaid upon the market acceptance curve 232. The market acceptance threshold 250 is the point in time and the point in market acceptance along a market acceptance curve which defines the consumer type (early adopter, early majority, late majority, laggard, or the like) that is acceptable to the user. The market acceptance threshold 250 may define the user as a middle late majority type of consumer, as is depicted in FIG. 4D. The market acceptance threshold 250 is used to make a SG retention recommendation to the user.

FIG. 4E illustrates an analytically determined market acceptance curve with market acceptance threshold overlaid thereupon. The market threshold 250 may be overlaid upon the market acceptance curve generated by the output module 230 by the analytics module 220. The market threshold 250 may be overlaid upon the market acceptance curve by segmenting the fitted market acceptance curve into curve segments (i.e. incoming segment, pre peak segment, peak, post peak, outgoing, etc.) and placing the market threshold 250 upon the fit market acceptance curve at the same curve segment location that corresponds with the defined market threshold 250. If the analytically determined market acceptance curve ends to the left of the market acceptance threshold 250 as is shown in FIG. 4E, indicating the market acceptance of the SG is within an acceptable market acceptance period to the user, the analytics module recommends the SG should be retained by the user. If the analytically determined market acceptance curve ends to the right of the market acceptance threshold 250, indicating the market acceptance of the SG is not within an acceptable market acceptance period to the user, the analytics module recommends the SG should not be retained by the user.

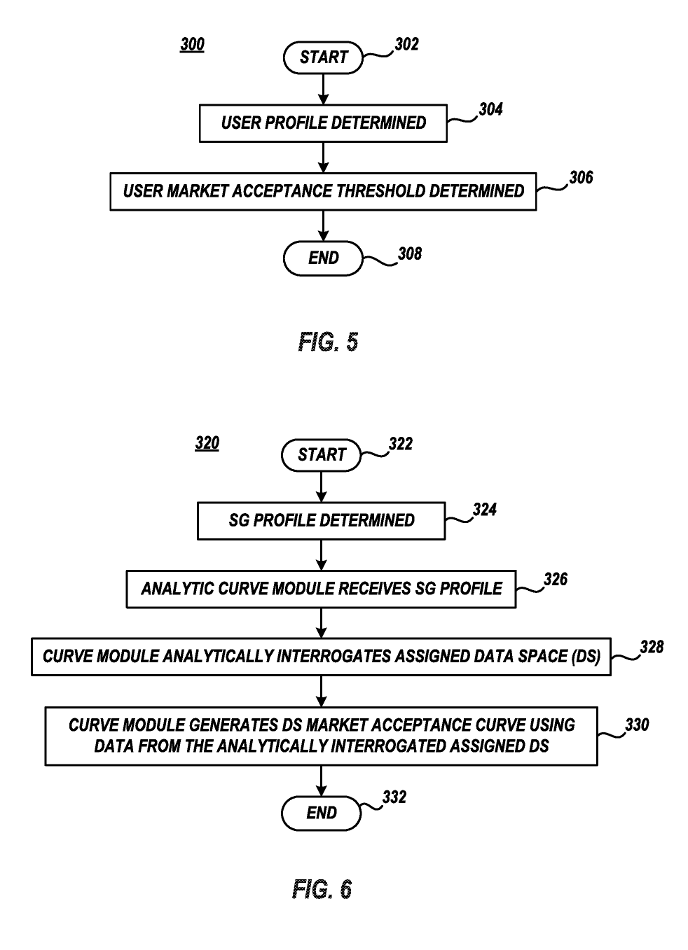

FIG. 5 illustrates an exemplary method 300 of determining a computer 100 user's market acceptance threshold 250, according to various embodiments of the present invention. Method 300 begins at block 302 and continues by background data module 200 determining a user profile 212 of the computer 100 user (block 304) and continues by background data module 200 determining the market acceptance threshold 250 of the computer 100 user (block 306). For example, a user profile module 210 within background data module 200 determines the user profile 212 by a question and answer module which queues questions to and receives inputs from the user of computer 100, asks the user whether he or she is early adopter consumer, early majority consumer, late majority consumer, laggard consumer. The data obtained by the user profile module 210 is used to determine market acceptance threshold 250. For example, if data obtained by the user profile module 210 indicates that the user is defined as an early majority consumer then user profile module 210 defines market acceptance threshold 250 to be within an early majority segment of a market acceptance curve. Likewise, if data obtained by the user profile module 210 indicates that the user is defined as a peak consumer, then user profile module 210 defines market acceptance threshold 250 to be at the peak of a market acceptance curve. Method 300 ends at block 308.

FIG. 6 illustrates an exemplary method 320 of analytically determining a market acceptance curve of a SG, according to various embodiments of the present invention. Method 320 begins at block 322 and continues by background data module 200 determining the SG profile 208 of a particular SG (block 324). For example, a user I/O device module 202 utilizes camera 126 and touch screen 124 to harvest background SG data. The computer 100 user captures an image of a code that is located upon, attached to, or otherwise associated with the SG. Subsequently, user I/O device module 202 scans the image of the code to harvest background data of the associated SG. Network module 204 optionally requests and receives supplemental or additional background data, associated with the particular SG, that is inherent to, integral to, or otherwise associated with the SG from a networked connected computer 180 that is controlled by an entity other than the user of computer 100. SG profile module 206 generally assembles the background data obtained from user I/O device module 202 and network module 204 into SG profile 208.

Method 320 may continue with an analytic curve module receiving the SG profile 208 (block 326). For example, online marketplace acceptance curve module 222, social media market acceptance curve module 224, and/or online periodical market acceptance curve module 226 receives the SG profile 208. The SG profile 208 is utilized by the online marketplace acceptance curve module 222, social media market acceptance curve module 224, and/or online periodical market acceptance curve module 226 to analytically interrogate an assigned or associated data space (block 328). For example, online marketplace acceptance curve module 222 analytically interrogates the online marketplace to determine the market acceptance of the SG therewithin, social media market acceptance curve module 224 analytically interrogates online social media webpage(s) to determine the market acceptance of the SG therewithin, and/or online periodical market acceptance curve module 226 analytically interrogates online periodical(s) to determine the market acceptance of the SG therewithin.

Method 320 may continue with the curve module generating a data space market acceptance curve utilizing the data from the analytically interrogated assigned data space (block 330). For example, online marketplace acceptance curve module 222 utilizes data from the analytical interrogation of the online marketplace to generate an online market acceptance curve of the SG, social media market acceptance curve module 224 utilizes data from the analytical interrogation of online social media webpage(s) to generate a social media market acceptance curve of the SG, and/or online periodical market acceptance curve module 226 utilizes data from the analytical interrogation of online periodical(s) to generate an online periodical market acceptance curve of the SG. Method 320 ends at block 332.

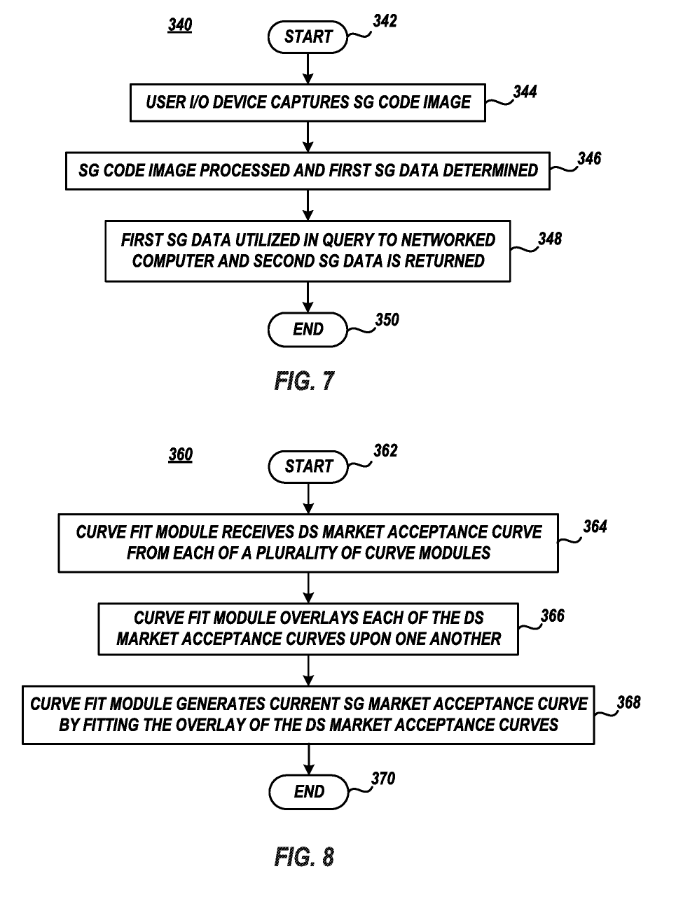

FIG. 7 illustrates an exemplary method 340 of determining background data of a SG, according to various embodiments of the present invention. Method 340 begins at block 342 and may continue with user I/O device 121 capturing a SG code image (block 344). For example, a user I/O device module 202 utilizes camera 126 and touch screen 124 capture a photograph image of a code located upon, attached to, or otherwise associated with the SG. Subsequently, user I/O device module 202 processes, scans, or the like, the image of the code to harvest first background data of the associated SG (block 346). Method 340 may continue with network module 204 receiving the first background data and utilizing the first background data to query and receive second background data of the associated SG from computer 180 (block 348). The networked connected computer 180 is controlled by an entity other than the user of computer 100 which includes at least the network module 204. Method 340 ends at block 350.

FIG. 8 illustrates an exemplary method 360 of generating a market acceptance curve of a SG, according to various embodiments of the present invention. Method 360 begins at block 362 and continues with a curve fit or output module receiving a respective data space market acceptance curve from each of a plurality of curve modules (block 364). For example, curve fit/output module 230 receives the generated online market acceptance curve of the SG, generated social media market acceptance curve of the SG, and/or generated online periodical market acceptance curve of the SG.

Method 360 may continue with the curve fit output module 230 overlaying or combining the data space market acceptance curves upon the same market acceptance curve axis. For example, fit output module 230 combines the online marketplace acceptance curve, the social media marketplace acceptance curve, and the periodical market acceptance curve. Method 360 may continue with the curve fit output module 230 generating a current market acceptance curve by fitting the overlay of the data space market acceptance curves (block 368). For example, curve fit output module 230 utilizes a best fit technique to fit a line to the combined or overlaid online marketplace acceptance curve, the social media marketplace acceptance curve, and the periodical market acceptance curve. In an embodiment, curve fit output module 230 may weight one particular data space market acceptance curve greater than another curve since it may be determined that the particular data space market acceptance curve more accurately describes the actual market acceptance of the SG. The higher weighting results in the fitted market acceptance curve to more resemble the higher weighted data space market acceptance curve. Method 360 ends at block 370.

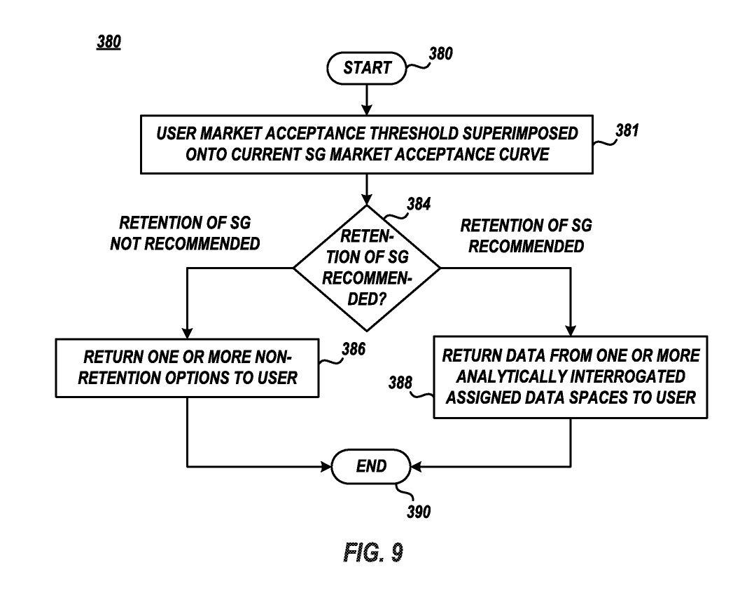

FIG. 9 illustrates an exemplary method 380 of managing retention of a SG based upon an analytically determined market acceptance curve associated with the SG, according to various embodiments of the present invention. Method 380 begins at block 380 and continues with analytics module 220 superimposing the market acceptance threshold 250 upon the fitted or current market acceptance curve (block 381). For example, the market threshold 250 is overlaid upon the market acceptance curve generated by the output module 230. The market threshold 250 may be overlaid upon the market acceptance curve by segmenting the fitted market acceptance curve into curve segments (i.e. incoming segment, pre peak segment, peak, post peak, outgoing, etc.) and placing the market threshold 250 upon the fitted market acceptance curve at the same curve segment location as defined by the market threshold 250.

Method 380 may continue by determining whether a retention recommendation should be given to the user (block 384). A retention recommendation should be given to the user if the fitted market acceptance curve ends to the left of the market acceptance threshold 250, as is exemplary shown in FIG. 4E, which indicates the market acceptance of the SG is within an acceptable market acceptance period to the user. A non-retention recommendation should be given to the user if the fitted market acceptance curve ends to the right of the market acceptance threshold 250, which the market acceptance of the SG is not within an acceptable market acceptance period to the user.

If retention of the SG is recommended, data from one or more analytically interrogated data spaces is returned to the user (block 388) by the analytics module 220. For example, a percentage value of how similar the SG appears to be with other SG's found in images posted to social media webpages is returned to the user by displaying the percentage upon the touch screen 124, text describing the best way to style the SG found in an online periodical is returned to the user by displaying the text the user upon the touch screen 124, an image showing the SG found in an online store is returned to the user by displaying the image to the user upon the touch screen 124, or the like.

If retention of the SG is not recommended, one or more non retention options are presented to the user (block 386) by analytics module 220. For example, a sell SG object may be displayed to the user upon the touch screen 124, a donate SG object may be displayed to the user upon the touch screen 124. If the user selects or engages the sell SG object, the SG profile 208 may be used as an input to generate a SG sale listing. If the user selects the donate SG object, the location of the user found within user profile 212 may be used to determine the nearest charitable organization that will accept the SG, determine the charitable organization that is in most need of the particular type of SG, etc.

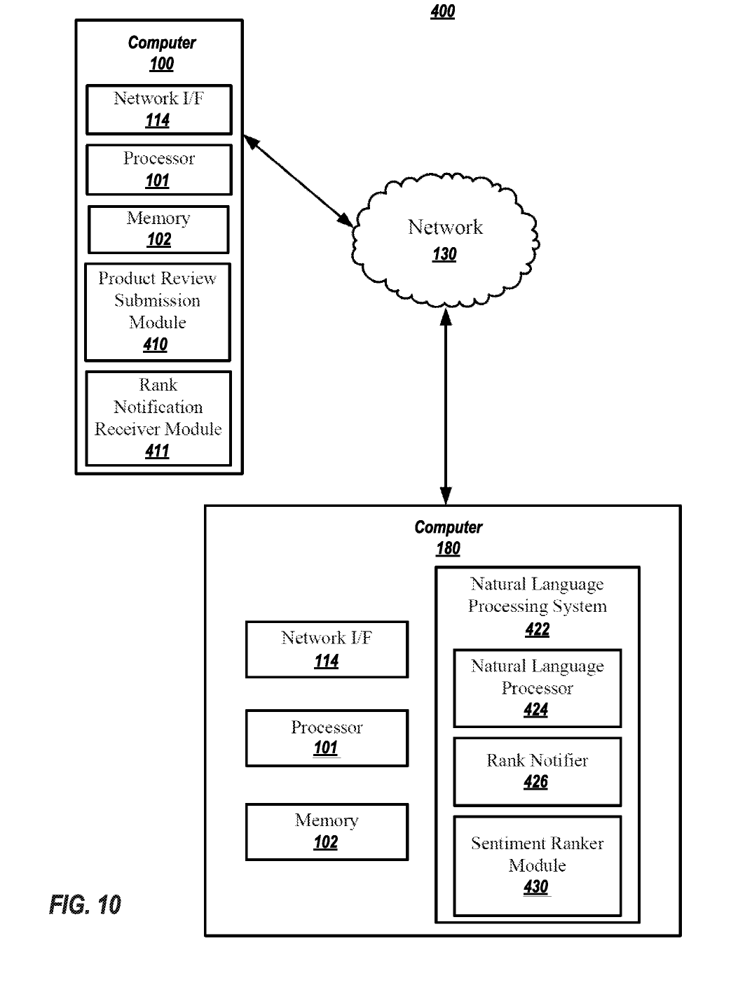

FIG. 10 illustrates a block diagram of an example computing environment 400 in which illustrative embodiments of the present disclosure may be implemented. In some embodiments, the computing environment 400 includes computer 100 which is configured as a remote device, which may be referred to herein as remote device, and a computer 180 which is configured as a host device, which may be referred to herein as host device.

The remote device and the host device may include any commercially available or custom software (e.g., browser software, communications software, server software, natural language processing software, search engine and/or web crawling software, filter modules for filtering content based upon predefined parameters, etc.). The remote device and the host device may be distant from each other and communicate over network 130. In some embodiments, the host device may be a central hub from which remote device can establish a communication connection, such as in a client-server networking model. Alternatively, the host device and remote device may be configured in any other suitable networking relationship (e.g., in a peer-to-peer configuration or using any other network topology).

In certain embodiments, the remote device and the host device may be local to each other and communicate via any appropriate local communication medium. For example, the remote device and the host device may communicate using a local area network (LAN), one or more hardwire connections, a wireless link or router, or an intranet. In some embodiments, the remote device and the host device may be communicatively coupled using a combination of one or more networks and/or one or more local connections. For example, the remote device may be hardwired to the host device (e.g., connected with an Ethernet cable) while a second remote device (not shown) may communicate with the host device using the network 130 (e.g., over the Internet).

In some embodiments, the network 130 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 130.

In some embodiments, the remote device may enable users to submit (or may submit automatically with or without user input) electronic documents (e.g., web pages) containing SG good product data, such as product reviews, to the host devices in order to have the SG good product data ingested and analyzed for sentiment or market acceptance (e.g., by natural language processing system 422). For example, the remote device may include product submission module 410 and a user interface (UI). The product submission module 410 may be in the form of a web browser or any other suitable software module, and the UI may be any type of interface (e.g., command line prompts, menu screens, graphical user interfaces). The UI may allow a user to interact with the remote device to submit, using the product submission module 410, one or more web pages containing product data, such as reviews, images, etc. about various SG products to the host device. In some embodiments, the product submission module 110 may incorporate a web crawler or other software that allows the module to search for and automatically identify SG product data for submission to the host device. In some embodiments, SG product data for similar SG products may be submitted together in a single group.

In some embodiments, the product data being submitted via the product submission module 410 may all belong to (or may have all been created on a website that is owned by) the same entity that is submitting them for analysis. This may occur, for example, when a retail website submits customer product reviews that were provided directly to the retail website by customers who shopped there. In some other embodiments, the entity submitting the product data may be different from the entity that originally received (e.g., collected) the product data from consumers. This may occur, for example, when a retail website obtains product reviews from a third party (e.g., a consumer survey company), for free or for a fee, and then submits these reviews for analysis.

In some embodiments, the remote device may further include a rank notification receiver module 411. This module may be configured to receive notifications, from the host device, of the relative ranks of various product features common to a group of SG products. In some embodiments, these relative ranks may then be used by the remote device to aid users in determining which SG product features are more important to consider when making a retention decision. For example, these rankings may incorporated (by either the remote device or the host device) into web pages that allow consumers to use these received rankings for sorting through SG products.

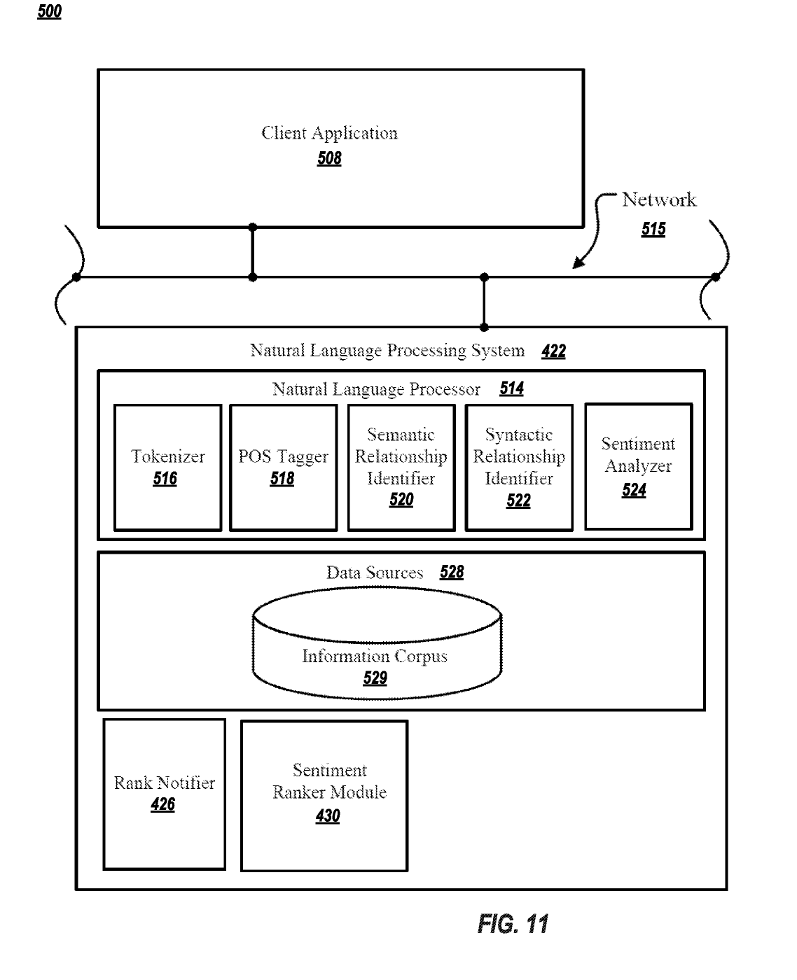

In some embodiments, the host device may include a natural language processing system 422. The natural language processing system 422 may include a natural language processor 424, a rank notifier 426, and a sentiment ranker module 430. The natural language processor 424 may include numerous subcomponents, such as a tokenizer, a part-of-speech (POS) tagger, a semantic relationship identifier, and a syntactic relationship identifier. An example natural language processor is discussed in more detail in reference to FIG. 11.

In some embodiments, the sentiment ranker module 430 may be configured to rank product features based on an analysis of the market acceptance associated with ingested and annotated SG product data. In addition, the rank notifier 426 may be connected to the sentiment ranker module 430 and may serve to notify a user at the remote system (e.g., via the rank notification receiver module 411) of the relative ranks of SG product features.

In some embodiments, the natural language processing system 422 may further include a search application (not shown). The search application may be implemented using a conventional or other search engine, and may be distributed across multiple computer systems. The search application may be configured to search one or more databases, data spaces, or other computer systems for product data that are related to a target SG product. For example, the search application may be configured to search a corpus of information related to a SG product associated with a submission by the product submission module 410 in order to identify additional relevant SG product market acceptance data.

While FIG. 10 illustrates a computing environment 400 with a single host device and a single remote device, suitable computing environments for implementing embodiments of this disclosure may include any number of remote devices and host devices. The various modules, systems, and components illustrated in FIG. 10 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to ingest and annotate product reviews, and the second host device may include a software module configured to compare and rank product features based on the ingested product reviews.

It is noted that FIG. 10 is intended to depict the representative major components of an exemplary computing environment 400. In some embodiments, however, individual components may have greater or lesser complexity than as represented in FIG. 10, components other than or in addition to those shown in FIG. 10 may be present, and the number, type, and configuration of such components may vary.

Referring now to FIG. 11, shown is a block diagram of an exemplary system architecture 500, including a natural language processing system 422, configured to use product data to rank product features, in accordance with embodiments of the present disclosure. In some embodiments, a remote device (such as computer 100 of FIG. 10) may submit electronic documents or webpages (containing SG product data to be analyzed) to the natural language processing system 422 which may be housed on a host device (such as computer 180 of FIG. 10). Such a remote device may include a client application 508, which may itself involve one or more entities operable to generate or modify information in the webpages that are then dispatched to a natural language processing system 422 via a network 515.

Consistent with various embodiments, the natural language processing system 422 may respond to electronic document submissions sent by the client application 508. Specifically, the natural language processing system 422 may analyze received SG product data to aid in the analysis of the relative importance of product features for consumer consideration. In some embodiments, the natural language processing system 422 may include a natural language processor 514, data sources 528, a rank notifier 426, and a sentiment ranker module 430.

The natural language processor 514 may be a computer module that analyzes the received product data within the electronic documents. The natural language processor 514 may perform various analytic methods and techniques for analyzing electronic documents (e.g., syntactic analysis, semantic analysis, etc.). The natural language processor 514 may be configured to recognize and analyze any number of natural languages. In some embodiments, the natural language processor 514 may parse passages of the documents. Further, the natural language processor 514 may include various modules to perform analyses of product data. These modules may include, but are not limited to, a tokenizer 516, a part-of-speech (POS) tagger 518, a semantic relationship identifier 520, a syntactic relationship identifier 522, and sentiment analyzer 524.

In some embodiments, the tokenizer 516 may be a computer module that performs lexical analysis. The tokenizer 516 may convert a sequence of characters into a sequence of tokens. A token may be a string of characters included in an electronic document and categorized as a meaningful symbol. Further, in some embodiments, the tokenizer 516 may identify word boundaries in an electronic document and break any text passages within the document into their component text elements, such as words, multiword tokens, numbers, and punctuation marks. In some embodiments, the tokenizer 516 may receive a string of characters, identify the lexemes in the string, and categorize them into tokens.

Consistent with various embodiments, the POS tagger 518 may be a computer module that marks up a word in passages to correspond to a particular part of speech. The POS tagger 518 may read a passage or other text in natural language and assign a part of speech to each word or other token. The POS tagger 518 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed electronic documents (e.g., the content of one product review may shed light on the meaning of text elements in another product review, particularly if they are reviews of the same product). Examples of parts of speech that may be assigned to words include, but are not limited to, nouns, verbs, adjectives, adverbs, and the like. Examples of other part of speech categories that POS tagger 518 may assign include, but are not limited to, comparative or superlative adverbs, wh-adverbs, conjunctions, determiners, negative particles, possessive markers, prepositions, wh-pronouns, and the like. In some embodiments, the POS tagger 518 may tag or otherwise annotate tokens of a passage with part of speech categories. In some embodiments, the POS tagger 518 may tag tokens or words of a passage to be parsed by other components of the natural language processing system 512.

In some embodiments, the semantic relationship identifier 520 may be a computer module that is configured to identify semantic relationships of recognized text elements (e.g., words, phrases) in documents. In some embodiments, the semantic relationship identifier 520 may determine functional dependencies between entities and other semantic relationships.

Consistent with various embodiments, the syntactic relationship identifier 522 may be a computer module that is configured to identify syntactic relationships in a passage composed of tokens. The syntactic relationship identifier 522 may determine the grammatical structure of sentences such as, for example, which groups of words are associated as phrases and which word is the subject or object of a verb. The syntactic relationship identifier 522 may conform to formal grammar.

Consistent with various embodiments, the sentiment analyzer 524 may be a computer module that is configured to identify and categorize the sentiments associated with tokens of interest. In some embodiments, the sentiment analyzer may be configured to identify, within text passages, and annotate keywords that are preselected as high quality indicators of sentiment polarity (e.g., indicators of positive sentiment could include brilliant, excellent, or fantastic). Various tools and algorithms may be used the sentiment analyzer 524 as are known to those skilled in the art (e.g., Naïve Bayes lexical model).

In some embodiments, the natural language processor 514 may be a computer module that may parse a document and generate corresponding data structures for one or more portions of the document. For example, in response to receiving a set of product reviews from a website that includes a collection of consumer product reviews at the natural language processing system 422, the natural language processor 514 may output parsed text elements from the product reviews as data structures. In some embodiments, a parsed text element may be represented in the form of a parse tree or other graph structure. To generate the parsed text element, the natural language processor 514 may trigger computer modules 516-524.

In some embodiments, the output of the natural language processor 514 may be stored as an information corpus 529 in one or more data sources 528. In some embodiments, data sources 528 may include data warehouses, information corpora, data models, and document repositories. The information corpus 529 may enable data storage and retrieval. In some embodiments, the information corpus 529 may be a storage mechanism that houses a standardized, consistent, clean, and integrated copy of the ingested and parsed product reviews. Data stored in the information corpus 529 may be structured in a way to specifically address analytic requirements. For example, the information corpus 529 may store the ingested product data based on groups of related products (e.g., products of the same type) in order to make ranking product features easier. In some embodiments, the information corpus 529 may be a relational database.

In some embodiments, the natural language processing system 422 may include a sentiment ranker module 430. The sentiment ranker module 430 may be a computer module that is configured to generate market acceptance scores for specific forms of product features based on the analysis of annotated product data. The sentiment ranker module 430 may be further configured to rank the product features based on these market acceptance scores.

The rank notifier 426 may be a computer module that is configured to notify users of product features rankings determined by the sentiment ranker module 430. In some embodiments, the rank notifier 426 may communicate with a rank notification receiver module (such as module 411 of FIG. 10). For clarity, analytics module 220 may utilize the product submission module 410, rank notification receiver module 411, natural language processing system 422, etc. to harvest market acceptance data from within the associated assigned data space.

The flowcharts and block diagrams in the Figures illustrate exemplary architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method of managing retention of a softline good (SG) with a computer comprising a processor and memory, the method comprising:
analyzing an image of a code upon a label that is attached to the SG to determine a SG identifier
generating, with a SG profile module stored upon the memory, a SG profile comprising the SG identifier;
recommending, with an analytics module stored upon the memory, whether the SG should be retained by:
generating, with the analytics module stored upon the memory, a first market acceptance curve from first harvested data from a first assigned data space;
generating, with the analytics module, a second market acceptance curve from second harvested data from a second assigned data space;
generating, with the analytics module, a best fit market acceptance curve of the first market acceptance curve and the second market acceptance curve; and
determining whether the best fit market acceptance curve extends beyond a predetermined market acceptance threshold.

2. The method of claim 1, further comprising:
capturing, with one or more user I/O devices of the computer, the image of the code upon the label attached to the SG; and
scanning, with a user I/O device module stored upon the memory, the image of the code upon the label.

3. The method of claim 1, wherein generating the SG profile comprises:
requesting and receiving, with a network module stored upon the memory, supplemental SG data from a networked computer attached to the computer via a network, the networked computer controlled by a SG supply chain entity other than the user.

4. The method of claim 1, wherein the market acceptance threshold is defined within a profile of the user stored upon the memory.

5. The method of claim 1, wherein generating the best fit market acceptance curve comprises:
weighing the first market acceptance curve higher than the second market acceptance curve and resultantly generating the best fit market acceptance curve more similar to the first market acceptance curve.

6. The method of claim 1, wherein the market acceptance threshold defines a consumer type to the user.

7. The method of claim 1, further comprising:
if the best fit market acceptance curve does not extend beyond the predetermined market acceptance threshold of the user of the computer, recommending that the SG should be retained; and
returning first harvested data or second harvested data to the user.

8. The method of claim 7, wherein returning first harvested data or second harvested data to the user comprises:
display an image of the SG that was harvested by the analytics module from the first assigned data space or second assigned data space upon a touch screen of the computer.

9. The method of claim 1, further comprising:
if the best fit market acceptance curve do extend beyond the predetermined market acceptance threshold of the user of the computer, recommending that the SG should not be retained; and
returning one or more SG dispossession options to the user.

10. The method of claim 9, wherein returning one or more SG dispossession options to the user comprises:
generating a sale listing, with the analytics module, utilizing the SG profile.

11. A computer program product for managing retention of a softline good (SG) with a computer, the computer program product comprising a computer readable storage medium having program instructions embodied therewith, the program instructions readable by the computer to cause the computer to:
analyze an image of a code upon a label that is attached to the SG to determine a SG identifier generate a SG profile comprising the SG identifier;
recommend whether the SG should be retained by:
generating, with an analytics module stored upon the memory, a first market acceptance curve from first harvested data from a first assigned data space;
generating, with the analytics module, a second market acceptance curve from second harvested data from a second assigned data space;
generating, with the analytics module, a best fit market acceptance curve of the first market acceptance curve and the second market acceptance curve; and
determining whether the best fit market acceptance curve extends beyond a predetermined market acceptance threshold.

12. The computer program product of claim 11, wherein the program instructions are further readable by the computer to cause the computer to:
produce the image of the code upon the label attached to the SG; and
scan the image of the code upon the label.

13. The computer program product of claim 11, wherein the program instructions that cause the computer to generate the SG profile further cause the computer to:
request and receive supplemental SG data from a networked computer attached to the computer via a network, the networked computer controlled by a SG supply chain entity other than the user.

14. The computer program product of claim 11, wherein the market acceptance threshold is defined within a profile of the user stored upon a memory of the computer.

15. The computer program product of claim 11, wherein the program instructions that cause the computer to generate the best fit market acceptance curve further cause the computer to:
assign the first market acceptance curve as more relevant than the second market acceptance curve and resultantly generate the best fit market acceptance curve more similar to the first market acceptance curve relative to the second market acceptance curve.

16. The computer program product of claim 11, wherein the market acceptance threshold defines a consumer type to the user.

17. The computer program product of claim 11, wherein the program instructions are further readable by the computer to cause the computer to:
recommend that the SG should be retained if the best fit market acceptance curve does not extend beyond the predetermined market acceptance threshold of the user of the computer; and
return first harvested data or second harvested data to the user.

18. The computer program product of claim 17, wherein the program instructions that cause the computer to return first harvested data or second harvested data to the user further cause the computer to:
display an image of the SG that was harvested from the first assigned data space or second assigned data space upon a touch screen of the computer.

19. The computer program product of claim 11, wherein the program instructions are further readable by the computer to cause the computer to:
recommend that the SG should not be retained if the best fit market acceptance curve does extend beyond the predetermined market acceptance threshold of the user of the computer; and
return one or more SG dispossession options to the user, wherein the program instructions that cause the computer to return one or more SG dispossession options to the user further cause the computer to generate a sale listing with the SG profile.

20. A computer comprising:
a processor; and
memory communicatively coupled to the processor, wherein the memory is encoded with instructions, wherein the instructions when executed by the processor cause the processor to:
analyze an image of a code upon a label that is attached to the SG to determine a SG identifier
generate a SG profile comprising the SG identifier;
recommend whether the SG should be retained by:
generating, with an analytics module stored upon the memory, a first market acceptance curve from first harvested data from a first assigned data space;
generating, with the analytics module, a second market acceptance curve from second harvested data from a second assigned data space;
generating, with the analytics module, a best fit market acceptance curve of the first market acceptance curve and the second market acceptance curve; and
determining whether the best fit market acceptance curve extends beyond a predetermined market acceptance threshold.
